(19) United States
(12) Patent Application Publication
(10) Pub. No.: US 2026/0196422 A1
(43) Pub. Date: Jul. 9, 2026

(54) DAMPER COMPONENT FOR REDUCING BOUNCING EFFECT ON CIRCUIT BREAKER CONTACTS DURING SWITCH ON PROCESS

(71) Applicant: Rockwell Automation Switzerland GmbH, Aarau (CH)

(72) Inventors: Rahel J. von Arx-Rotach, Schinznach-Dorf (CH); Beat Villiger, Reinach (CH); Sadashiv Pimple, Mattenweg 6 (CH); Sandro Liberto, Aarau (CH)

(21) Appl. No.: 19/015,108

(22) Filed: Jan. 9, 2025

(51) Int. Cl. H01H 19/14; H01H 3/38; H01H 69/00; H01H 71/10

(52) U.S. Cl. CPC H01H 19/14; H01H 3/38; H01H 69/00; H01H 71/10

(57) ABSTRACT

The present technology relates to a damping feature of industrial circuit breakers. More specifically, a mechanism is disclosed that reduces bouncing effects between components in a circuit breaker when the circuit breaker turns from an off position to an on position. In an embodiment, a circuit breaker includes a damper component disposed to absorb a shock in the circuit breaker created by a spring that forces a set of moving contacts to engage with a set of stationary contacts when switching the circuit breaker on. In such a scenario, the damper component cushions the movement of components in the circuit breaker to reduce a bouncing effect between the set of moving contacts and the set of stationary contacts.

### TECHNICAL FIELD

Various embodiments of the present technology generally relate to industrial circuit breakers, and more particularly, to a damping mechanism that reduces bouncing effects in a circuit breaker when the circuit breaker turns from an off position to an on position.

### BACKGROUND

Circuit breakers are electrical switching devices designed to protect electrical circuits from potential damage that can be caused by short circuits or overloads. Circuit breakers may be implemented in industrial environments as components of electrical circuits. When an electromechanical circuit breaker is turned on, an electrical connection is created by bringing sets of metal contacts into physical contact with one another to allow current flow through the circuit. When the circuit breaker is turned off, the metal contacts are separated to interrupt the current flow in the circuit. Circuit breakers may be manually or automatically operated to switch the circuit breaker on and off.

In operation, turning the circuit breaker on causes various mechanical components of the circuit breaker to move, and as a result, causes a set of metal contacts to move from one position to another position in which the sets of metal contacts physically contact one another. Based on the space between the sets of metal contacts when the circuit breaker is off, and a difference between a force applied by components keeping the sets of metal contacts separated relative to a force applied to bring the sets of metal contacts together, the sets of metal contacts can bounce off each other temporarily before remaining in physical contact with one another. This bouncing effect can produce a physical shock throughout the circuit breaker causing potential damage to the mechanical components of the circuit breaker and impacting the durability of the circuit breaker.

To reduce or eliminate this bouncing effect, some circuit breakers limit the space between the sets of metal contacts while in the off position. However, if the distance between the sets of metal contacts is too small, electrical issues (e.g., arcing) may occur during operation of the circuit breaker. Accordingly, this solution can not fully address the bouncing effect issue.

It is with respect to this general technical environment that aspects of the present disclosure have been contemplated. Furthermore, although a general environment is discussed, it should be understood that the described examples should not be limited to the general environment identified in the background.

### SUMMARY

Systems, devices, and methods are disclosed herein related to industrial circuit breakers, and more particularly, to damping features of industrial circuit breakers. In operation, a circuit breaker can be turned on to allow current flow through the circuit breaker and turned off to prevent current flow and protect electrical circuits from potential damage that can be caused by short circuits or overloads. When the circuit breaker is turned on, various components in the circuit breaker shift positions. The positional shifts may result in shaking or bouncing of some components, which could damage the components. A damping mechanism is disclosed that reduces such bouncing effects.

In an embodiment of the present technology, a circuit breaker includes a rotating switch coupled to a linkage assembly. The switch includes an on position corresponding to an on mode of the circuit breaker, an off position corresponding to an off mode of the circuit breaker, and a trip position corresponding to a trip mode of the circuit breaker. The circuit breaker includes the linkage assembly movable axially along a first axis as the switch rotates. The circuit breaker further includes a set of stationary contacts, a set of moving contacts, a spring coupled to the set of moving contacts, and a damper component coupled to the linkage assembly. The set of moving contacts change position between a first position corresponding to the off position of the switch and a second position corresponding to the on position of the switch in response to movement of the linkage assembly caused by rotation of the switch between the off position and the on position. The set of moving contacts do not physically touch the set of stationary contacts in the first position stopping current flow through the circuit breaker in the off mode, while the set of moving contacts physically touch the set of stationary contacts in the second position allowing current flow through the circuit breaker in the on mode. The spring provides a force that opposes a force produced by the movement of the linkage assembly to enable a position change of the set of moving contacts based on the rotation of the switch. The damper component includes a cushioning material and is disposed to absorb a shock created by the force produced by the spring when the set of moving contacts changes position between the first position and the second position thereby cushioning the movement of the linkage assembly.

In another embodiment of the present technology, a circuit breaker is provided that includes a switch, a linkage assembly coupled to the switch, a set of stationary contacts, a set of moving contacts coupled to the linkage assembly, a spring coupled to the set of moving contacts, and a damper component coupled to the linkage assembly. The switch is rotatable from an off positioning corresponding to an off mode of the circuit breaker to an on position corresponding to an on mode of the circuit breaker. In response to the rotation of the switch, the linkage assembly moves from a first position corresponding to the off mode of the circuit breaker to a second position corresponding to the on mode of the circuit breaker. The movement of the linkage assembly from the first position to the second position reduces a force applied by the linkage assembly on the spring, which causes the set of moving contacts to engage with the set of stationary contacts. The engagement of the sets of contacts produces a shock. The damper component collides with an element of the linkage assembly to absorb at least a portion of the shock, thereby reducing a bouncing effect between the sets of contacts.

In yet another embodiment of the present technology, a method of manufacturing a circuit breaker that reduces a bouncing effect between a set of moving contacts and a set of stationary contacts of the circuit breaker is provided. The method includes positioning a switch rotatable from an off position corresponding to an off mode of the circuit breaker to an on position corresponding to an on mode of the circuit breaker, coupling a linkage assembly to the switch movable from a first position corresponding to the off mode of the circuit breaker to a second position corresponding to the on mode of the circuit breaker in response to rotation of the switch, coupling the set of moving contacts to the linkage assembly, coupling a spring to the set of moving contacts, and coupling a damper component to the linkage assembly. The movement of the linkage assembly from the first position to the second position reduces a force applied by the linkage assembly on the spring causing the set of moving contacts to engage with the set of stationary contacts. The engagement of the set of moving contacts with the set of stationary contacts produces a shock. The damper component collides with an element of the linkage assembly to absorb at least a portion of the shock thereby reducing the bouncing effect between the set of moving contacts and the set of stationary contacts.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

While multiple embodiments are disclosed, still other embodiments of the present technology will become apparent to those skilled in the art from the following detailed description, which shows and describes illustrative embodiments of the invention. As will be realized, the technology is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1A illustrates an example circuit breaker in an off mode, according to some embodiments.

FIG. 1B illustrates an example circuit breaker in an on mode, according to some embodiments.

FIG. 2 illustrates aspects of an example damper component of a circuit breaker, according to some embodiments.

FIGS. 3A and 3B illustrate aspects of an example damper component of a circuit breaker, according to some embodiments.

FIG. 4 illustrates sample results with respect to voltage measured in a circuit breaker, according to some embodiments.

FIG. 5 illustrates an example circuit breaker, according some embodiments.

FIGS. 6A-6C illustrate three positions of a circuit breaker switch on a circuit breaker faceplate, according to some embodiments.

FIG. 7 illustrates an example of a circuit, according to some embodiments.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Technology is disclosed herein that mitigates the problems discussed about with respect to reducing bouncing effects (also referred to as “chatter”) within industrial circuit breakers, and more generally, to improving circuit breaker reliability with respect to turn-on time. A circuit breaker is a switching device that interrupts current during fault conditions or overload situations, thereby preventing damage caused by overcurrent. In industrial or commercial environments, circuit breakers are used to protect various electrical systems and devices while the systems and devices perform industrial automation operations. For example, a circuit breaker may be included in a circuit of a system powered by an alternating current (AC) power source (e.g., AC mains). In operation, the circuit breaker can be turned on to allow current flow from the AC power source through the circuit breaker and through the system to allow the system to perform respective functions. The circuit breaker can also be turned off to prevent current flow and protect the system from potential damage that can be caused by short circuits or overloads.

Often, circuit breakers include numerous mechanical components that move and shift positions to allow current flow (i.e., turn on) and prevent current flow (i.e., turn off). For example, a circuit breaker includes sets of metal contacts that, when physically touching complete a circuit and allow current flow through the circuit breaker, and also that, when physically separated break the circuit and prevent current flow through the circuit breaker. The sets of metal contacts may be brought into physical contact by various components, such as gears, springs, and the like. Problematically, as mentioned above, positional shifts in the mechanical components of the circuit breaker may result in shaking or bouncing of some components, which could damage the components and reduce the physical and electrical durability of the circuit breaker over time. Bouncing may refer to the sets of contacts disengaging and re-engaging with each other repeatedly, which may inadvertently prevent current flow at least momentarily and temporarily, affecting the electrical reliability of the circuit breaker.

To address these issues, a circuit breaker described herein includes a damping mechanism that reduces such bouncing effects. More specifically, the circuit breaker includes a damper component disposed to absorb a shock in the circuit breaker created by elements of the circuit breaker (e.g., a spring mechanism) that produce a force capable of closing the circuit breaker causing a set of metal contacts to engage with another set of metal contacts and turning the circuit breaker on. In such a scenario, the damper component cushions the movement of other components in the circuit breaker to reduce a bouncing effect between the set of moving contacts and the set of stationary contacts and to reduce the shock created by the elements that function to close the circuit breaker.

Advantageously, the damper component may prolong the durability and lifespan of the circuit breaker and its mechanical components as the damper component can hinder movement among the mechanical components reducing unwanted or unintended collisions. Furthermore, the damper component may reduce chatter between the sets of metal contacts of the circuit breaker allowing the sets of metal contacts to remain engaged with each other sooner relative to other circuit breakers. In turn, this allows steady current flow through the circuit breaker sooner and may prevent electrical issues in the circuit breaker, such as arcing, improving electrical durability of the circuit breaker and the system that includes the circuit breaker.

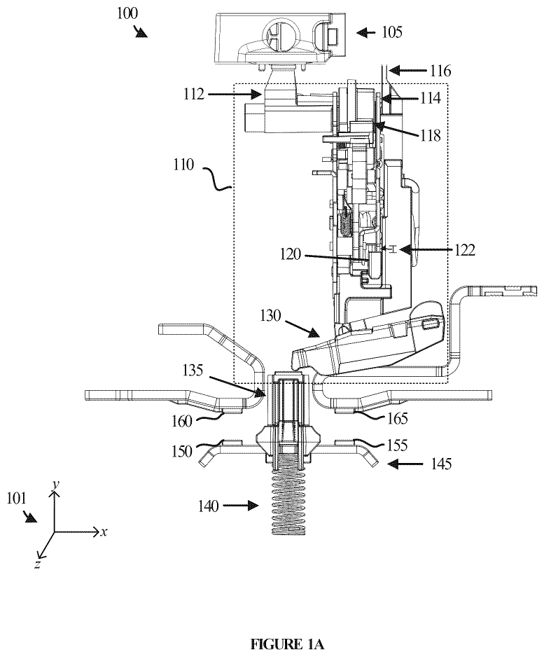

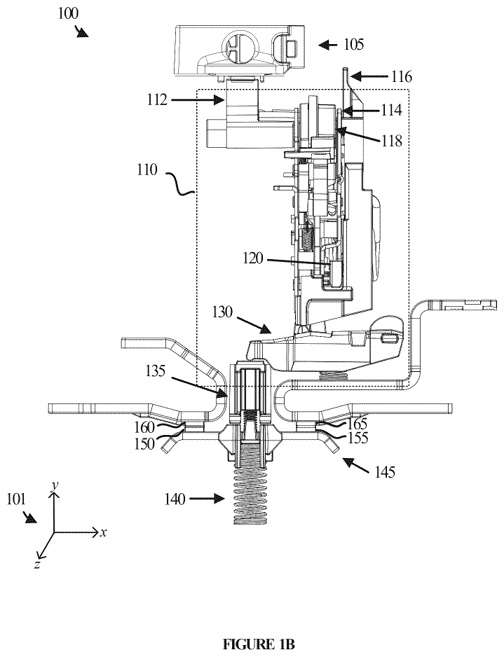

Turning now to the Figures, FIGS. 1A and 1B illustrate system 100. System 100 is representative of a circuit breaker in which embodiments of the present technology may be implemented. FIGS. 1A and 1B show only a portion of the components that make up system 100 in accordance with the present disclosure. For example, system 100 includes additional componentry, such as an external cover, omitted from FIGS. 1A and 1B for the sake of clarity. As shown in FIGS. 1A and 1B, system 100 includes switch 105, linkage assembly 110, plunging mechanism 135, plunging spring 140, switching element 145, moving contacts 150 and 155, and stationary contacts 160 and 165. Linkage assembly 110 includes rotary disk 112, gearing component 114, rocker 116, mechanism plate 118, damper component 120, and rocker arm 130. System 100 may include additional components as compared to what is shown in the example of FIGS. 1A and 1B or may include fewer components than what is shown in FIGS. 1A and 1B. FIGS. 1A and 1B further include axes 101, in reference to which elements of FIG. 1 are described.

Referring generally to system 100, switch 105 is a rotary switch on an outside surface of the circuit breaker that, in some examples, can be rotated between three positions: “ON,” “OFF,” and “TRIP.” In some examples, switch 105 rotates ninety degrees between “ON” and “OFF.” Switch 105 rotates about a first axis that runs through the center of the switch. The first axis is parallel to the y-axis. Switch 105 rotates in an x-z plane. Switch 105 is directly coupled to linkage assembly 110, and more specifically, to rotary disk 112 such that when switch 105 is rotated, rotary disk 112 also rotates. In some examples, switch 105 and rotary disk 112 may be described as a single component, given that they may be permanently affixed to one another in some embodiments. Thus, rotary disk 112 rotates simultaneously with switch 105 and about the same axis as switch 105. Rotary disk 112 also rotates in an x-z plane shifted in the −y direction from the x-z plane in which switch 105 rotates. By way of example, FIG. 1A shows a view of system 100 when switch 105 is in the “OFF” position corresponding to an “OFF” mode of the circuit breaker, in which moving contacts 150 and 155 do not physically touch stationary contacts 160 and 165, respectively, while FIG. 1B shows a view of system 100 when switch 105 is in the “ON” position corresponding to an “ON” mode of the circuit breaker, in which moving contacts 150 and 155 engage with and physically touch stationary contacts 160 and 165, respectively.

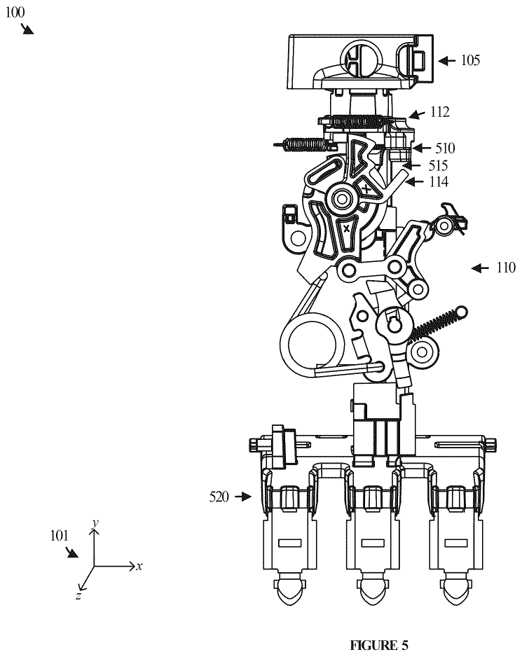

Rotary disk 112, as a result of being coupled to switch 105, rotary disk 112 also turns between the “ON” and the “OFF” position and may include the intermediary “TRIP” position. Although not visible in FIG. 1, rotary disk 112, in an embodiment of the present invention, includes a gear interface (see, e.g., FIG. 5, gear interface 510) on its circumferential edge configured to interface with gearing component 114. The gear interface on the circumferential edge of rotary disk 112 protrudes from the edge of rotary disk 112 towards gearing component 114 (i.e., along the y-axis) and is configured to interface (i.e., engage) with a notch (see, e.g., notch 515 in FIG. 5) in gearing component 114 such that when rotary disk 112 rotates, the gear interface pushes gearing component 114 via the notch. Gearing component 114 includes one or more components that work together to translate rotation of rotary disk 112 to axial movement of linkage assembly 110 (i.e., along the y-axis of axes 101), including axial movement of rocker 116 of linkage assembly 110. In response to being pushed by the gear interface via the notch, one or more rotary components of gearing component 114 rotate about an axis parallel to the x-axis to translate the rotation to linkage assembly 110.

As described, gearing component 114 translates the rotation of rotary disk 112 to axial movement of linkage assembly 110. Gearing component 114 contacts a proximal end of rocker 116 of linkage assembly 110 (i.e., the end nearest to rotary disk 112, in the +y direction). Linkage assembly 110 includes a plurality of moving components including rocker 116 and rocker arm 130, but in whole shifts along the y-axis to open and close the circuit breaker (i.e., disengage and engage the sets of moving and stationary contacts, respectively) via rocker arm 130.

Rocker arm 130 is located on a distal end of linkage assembly 110 (i.e., the end farthest from rotary disk 112, in the −y direction). When linkage assembly 110 is pushed in the −y direction by gearing component 114, linkage assembly 110 uses rocker arm 130 to open the circuit breaker's contacts. Rocker arm 130, in the present example, is a linear device that pivots about a rear axis (i.e., at the −x end of rocker arm 130). Rocker arm 130 is coupled to linkage assembly 110 on a first side of rocker arm 130 and a spring on a second side of rocker arm 130. Thus, when linkage assembly 110 shifts in the −y direction in response to switch 105 being turned toward the “OFF” position, rocker arm 130 is pushed in the −y direction (pivoting about the read end) such that a front end (i.e., the end farthest in the +x direction) pushes plunging mechanism 135 in the −y direction as well. As the front end of rocker arm 130 shifts in the −y direction, the spring coupled to rocker arm 130 is compressed. Alternatively, when linkage assembly 110 shifts in the +y direction in response to switch 105 being turned toward the “ON” position, rocker arm 130 moves in the +y direction as a result of being pulled by linkage assembly 110 and/or being pushed by the spring coupled to rocker arm 130. As a result, plunging mechanism 135 is freed to move in the +y direction, driven by plunging spring 140.

As mentioned, plunging mechanism 135, in response to being pushed by rocker arm 130, moves axially in the −y direction. Plunging mechanism 135 is coupled to plunging spring 140, which compresses in response to plunging mechanism 135 being pushed in the −y direction by rocker arm 130. Plunging mechanism 135 includes switching element 145. Switching element 145 is affixed to plunging mechanism 135 such that switching element 145 moves axially (along the y-axis) with plunging mechanism 135 when plunging mechanism 135 moves. Switching element 145 is comprised of two arms affixed to and extending laterally from plunging mechanism 135 in an x-z plane. Switching element 145 includes the moving contacts that separate from the stationary contacts to open the circuit breaker. Thus, moving contact 150 and moving contact 155 are each affixed to switching element 145 such that they move axially with switching element 145 and plunging mechanism 135. Thus, when the circuit breaker is turned off (i.e., opened), switching element, along with moving contact 150 and moving contact 155, shifts in the −y direction in response to plunging mechanism 135 being pushed in the −y direction by rocker arm 130 to separate moving contact 150 from stationary contact 160 and moving contact 155 stationary contact 165. Contrarily, when the circuit breaker is turned on (i.e., closed), switching element 145, along with moving contact 150 and moving contact 155, shift in the +y direction in response to plunging mechanism 135 being pushed in the +y direction by plunging spring 140 to bring moving contact 150 into contact with stationary contact 160 and moving contact 155 into contact with stationary contact 165.

Linkage assembly 110 also includes mechanism plate 118 representative of a support plate of the circuit breaker to which various components of linkage assembly 110 are coupled. Mechanism plate 118 is disposed adjacent to rocker 116 and extends along the y-axis from approximately the proximal end of rocker 116 to a medial portion of rocker 116. Gearing component 114 may be coupled to mechanism plate 118 at multiple points, such as at the proximal end of mechanism plate 118 (i.e., the end closest to gearing component 114, in the +y direction), at the medial end of mechanism plate 118, and at the distal end of mechanism plate 118 (i.e., the end farthest from rotary disk 112, in the −y direction). When components of linkage assembly 110 (e.g., elements of gearing component 114, rocker 116) are pushed in the −y direction when switch 105 is rotated, mechanism plate 118 may remain stationary.

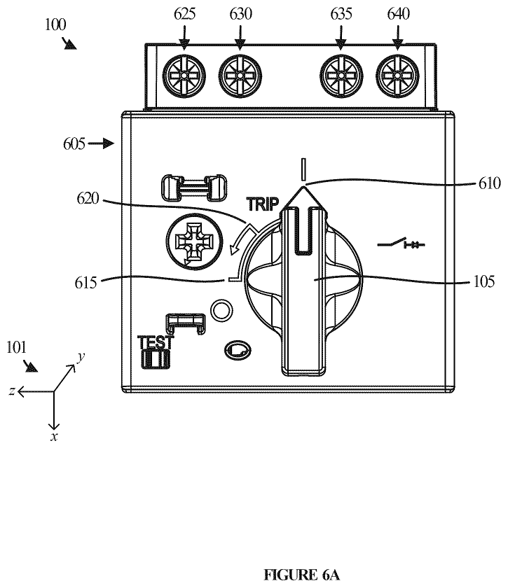

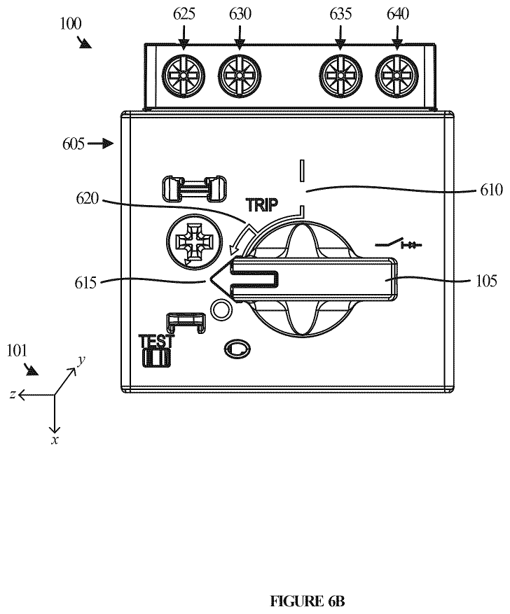

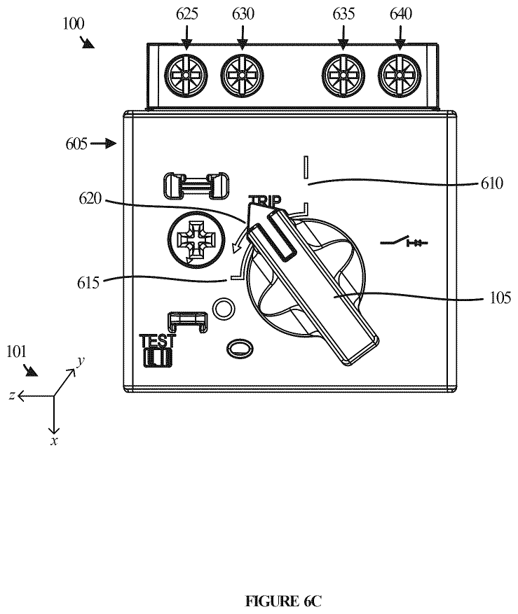

In operation, when system 100 is turned from the “ON” position to the “OFF” position (i.e., when the circuit breaker is opened and the moving contacts are disengaged from the stationary contacts), switch 105 is rotated counterclockwise (see, e.g., FIGS. 6A-6C) in an x-z plane on an external faceplate of the circuit breaker (see, e.g., FIGS. 6A-6C, switching faceplate 605). In response, rotary disk 112 also rotates from the “ON” position to the “OFF” position counterclockwise in an x-z plane, beneath the external faceplate of the circuit breaker. As rotary disk 112 rotates counterclockwise, a gear interface (e.g., gear interface 510) pushes gearing component 114, which translates the rotary motion of rotary disk 112 and switch 105 to axial movement of linkage assembly 110. Linkage assembly 110 shifts in the −y direction to push rocker arm 130, which pushes plunging mechanism 135 in the −y direction (i.e., rocker 116 and rocker arm 130 produce a force in the −y direction greater than an opposing force in the +y direction produced by plunging spring 140). As plunging mechanism 135 moves in the −y direction, plunging spring 140 is compressed and switching element 145 also moves in the −y direction, separating the moving contacts (i.e., moving contact 150 and moving contact 155) from the stationary contacts (i.e., stationary contact 160 and stationary contact 165) and opening the circuit breaker. FIG. 1A shows this state of the circuit breaker corresponding to the “OFF” position of the circuit breaker.

In the reverse, when system 100 is turned from the “OFF” position to the “ON” position (i.e., when the circuit breaker is closed and the moving contacts engage with and physically touch the stationary contacts), switch 105 is rotated clockwise (see, e.g., FIGS. 6A-6B) in an x-z plane on the external faceplate of the circuit breaker. In response, rotary disk 112 also rotates from the “OFF” position to the “ON” position clockwise in an x-z plane, beneath the external faceplate of the circuit breaker. As rotary disk 112 rotates clockwise, a gear interface (e.g., gear interface 510) pushes gearing component 114, which translates the rotary motion of rotary disk 112 and switch 105 to axial movement of linkage assembly 110. Linkage assembly 110 shifts in the +y direction to release and/or raise rocker arm 130, which releases plunging mechanism 135 to move in the +y direction as it is pushed by extension of plunging spring 140 (i.e., the force produced by plunging spring 140 in the +y direction overcomes the force produced by rocker 116 and rocker arm 130 in the −y direction). As plunging mechanism 135 moves in the +y direction, switching element 145 also moves in the +y direction, bringing the moving contacts (i.e., moving contact 150 and moving contact 155) back into physical contact with the stationary contacts (i.e., stationary contact 160 and stationary contact 165), thereby closing the circuit breaker. FIG. 1B shows this state of the circuit breaker corresponding to the “OFF” position of the circuit breaker.

Upon the closing of the circuit breaker, when the circuit breaker's contacts engage with each other (see, e.g., FIG. 1B), a shock may be produced throughout the circuit breaker from the force in the +y direction produced by plunging spring 140. The shock may cause some of the components of linkage assembly 110 to shake or move unintentionally and/or in unwanted ways, which may impact the durability of the circuit breaker and/or damage components of the circuit breaker. Additionally, the shock may cause a bouncing effect between the sets of contacts such that moving contacts 150 and 155 temporarily bounce away (in the −y direction) from stationary contacts 160 and 165, respectively, which may cause electrical issues (e.g., voltage ripples) with the circuit breaker.

To absorb this shock and reduce (and in some embodiments, potentially eliminate) the bouncing effect, linkage assembly 110 includes damper component 120 disposed on linkage assembly 110 to absorb such a shock. More particularly, damper component 120 is coupled to rocker 116 of linkage assembly 110 in an optimal position (e.g., to provide the greatest amount of shock absorption relative to other positions, to provide the most cushioning and movement reduction among components of linkage assembly 110 relative to other positions). By way of example, damper component 120 is disposed on a medial portion of rocker 116 within a gap between the distal end of mechanism plate 118 (i.e., the end farthest away from gearing component 114, in the −y direction) and a medial portion of rocker 116. As illustrated in FIG. 1A, when the circuit breaker is in the “OFF” position, gap 122 exists between a proximal end of damper component 120 (i.e., the end closest to mechanism plate 118, in the +y direction) and the distal end of mechanism plate 118. As illustrated in FIG. 1B, when the circuit breaker is in the “ON” position, gap 122 shrinks, and damper component 120 collides with mechanism plate 118 advantageously cushioning movement of components of linkage assembly 110 occurring when moving contacts 150 and 155 engage with stationary contacts 160 and 165, respectively, and thereby reducing the bouncing effect between the contacts.

In embodiments of the present technology, damper component 120 is disposed on a different location of linkage assembly. For example, in an exemplary embodiment, damper component 120 is coupled to rocker 116 in between the distal end of rocker 116 and a portion of rocker arm 130. In another exemplary embodiment, damper component 120 is coupled to the proximal end of rocker 116 such that damper component 120 collides with a portion of an external cover when rocker 116 moves axially in the +y direction upon the engagement of the sets of contacts. Regardless of the location of damper component 120, the position, orientation, and dimensions of damper component 120 may be selected such that damper component 120 collides with intended elements of the circuit breaker to provide damping and cushioning as described herein.

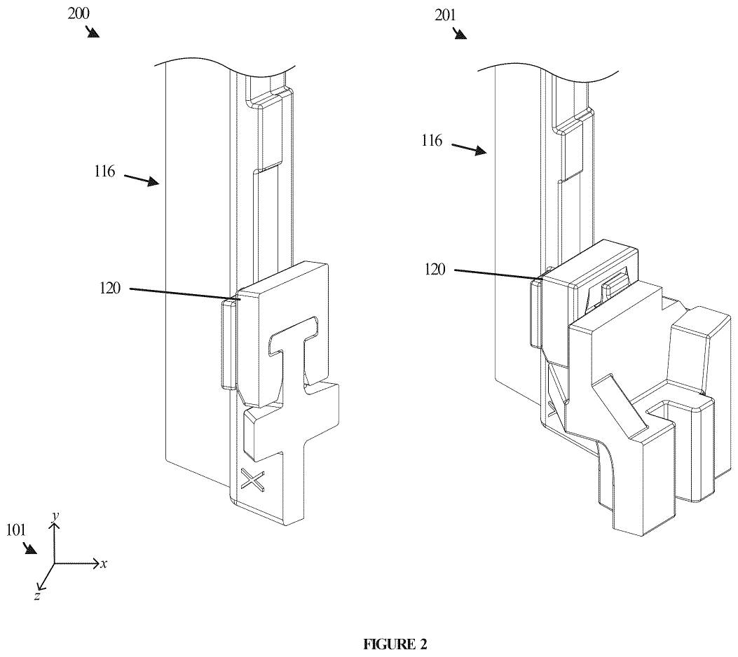

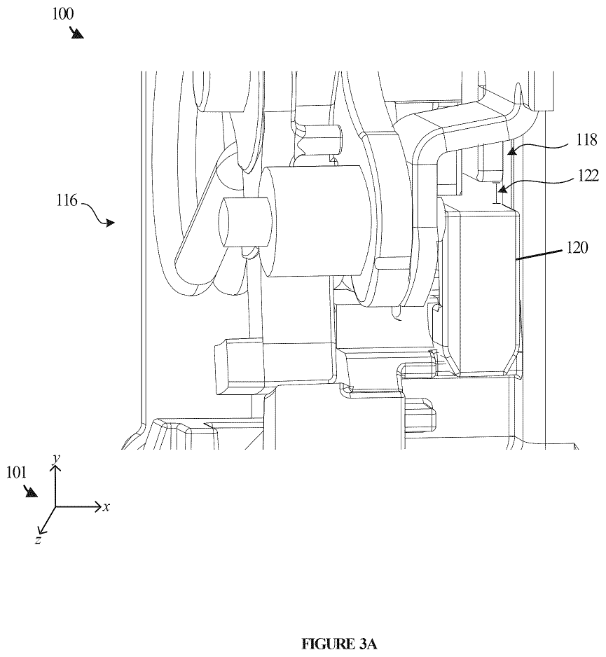

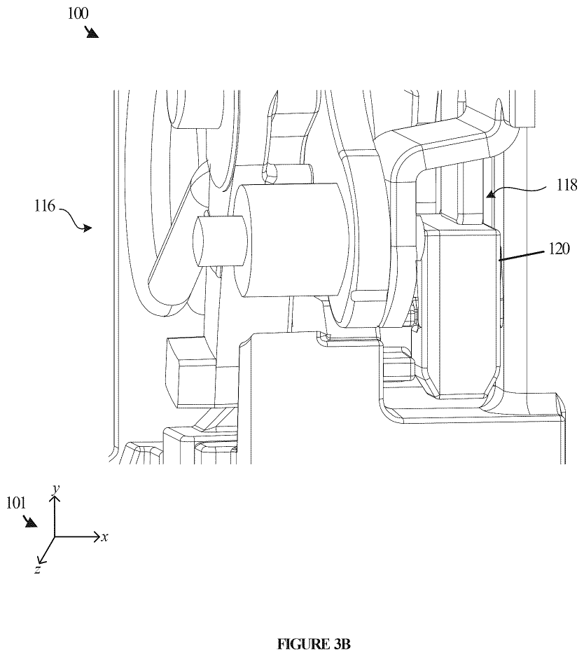

In embodiments of the present technology, various components of system 100 are comprised of metal, plastic, or both. For example, in an exemplary embodiment, switch 105, rotary disk 112, gearing component 114, and rocker arm 130 are all made of plastic. Additionally, some or all of the components that make up linkage assembly 110 may be made of plastic. Damper component 120 may be made of a shock absorbing material (i.e., cushioning material), such as a rubber material. In some embodiments, damper component 120 is made of another type of material capable of providing shock absorption and/or cushioning to reduce bouncing when the circuit breaker is closed, such as an elastomeric material. Additional information about damper component 120 is included below with respect to FIGS. 2, 3A, and 3B, and thus are excluded here for the sake of brevity.

Moving to FIG. 2, FIG. 2 illustrates example aspects of linkage assembly 110 of system 100 in accordance with some embodiments of the present technology. As such, FIG. 2 only includes a portion of the componentry that would make up system 100 in accordance with the present disclosure. System 100, as shown in FIG. 2, includes rocker 116 and damping component 120. FIG. 2 further includes axes 101, in reference to which elements of FIG. 2 are described.

FIG. 2 shows aspects 200 and 201, which illustrate isometric views of internal components of linkage assembly 110, rocker 116 and damper component 120. More particularly, aspect 200 shows a view demonstrating an exemplary shape of damper component 120, a position and orientation of damper component 120 relative to rocker 116, and how damper component 120 is coupled to rocker 116. Aspect 201 shows another view depicting additional details of rocker 116 and the location of damper 120 relative to portions of rocker 116.

Referring first to aspect 200, in an exemplary embodiment, damper component 120 includes a rectangular-shaped block having a T-shaped cutout or recess. The T-shaped opening of damper component 120 is located on a bottom side of damper component 120 (i.e., bottom referring to the lower-most portion of damper component 120 relative to the proximal end of rocker 116), while the top-side of damper component 120 (i.e., top referring to the upper-most portion of damper component 120 relative to the proximal end of rocker 116, in the +y direction) includes a flat surface. The other sides of damper component 120 may include flat surfaces with round or curved edges.

Damper component 120 is positioned adjacent (with respect to the y-axis) to a first portion of rocker 116 that extends along the y-axis. Damper component 120 is coupled to a second portion of rocker 116 that extends along the y-axis in parallel with respect to damper component 120. In particular, damper component 120 is coupled to this second portion via the T-shaped cutout on its bottom side. In this exemplary embodiment, this second portion of rocker 116 includes a T-shaped protrusion disposed within the T-shaped cutout of damper component 120, and thus, affixing damper component 120 to rocker 116.

As shown in aspect 201, rocker 116 includes a third portion positioned adjacent (with respect to the y-axis) to damper component 120 and to the second portion of rocker 116 extending from a medial portion of rocker 116 to the distal end of rocker 116. As such, damper component 120 is disposed between the first and third portions of rocker 116 and to the second portion of rocker 116.

In some embodiments, the dimensions of damper component 120 are selected based on the dimensions of the various portions of rocker 116, such that damper component 120 fits tightly to the T-shaped protrusion of rocker 116 and fits tightly between the first and third portions of rocker 116. Additionally, or alternatively, the dimensions of damper component 120 are selected based on a desired amount of force reduction percentage and/or shock absorption percentage, which may be determined based on various factors, such as the material of damper component 120, the amount of force produced in the −y direction by linkage assembly 110 on plunging mechanism 135, and the amount of force produced in the +y direction by plunging mechanism and plunging spring 140 on linkage assembly 110, among other factors.

Accordingly, in some embodiments, the material of damper component 120 may also be selected based on a desired amount of shock absorption based on such factors. For example, damper component 120 may include one or more materials effective in reducing shock, damping vibration and bouncing, and providing cushioning in collisions, such as silicone rubber, polyurethane, elastomers, thermoplastic elastomer, neoprene, nitrile rubber, cork-rubber composites, sorbothane, ethylene propylene diene monomer (EPDM) rubber, foamed elastomers, and the like.

FIGS. 3A and 3B illustrate aspects of linkage assembly 110 of system 100 in accordance with some embodiments of the present technology. As such, FIGS. 3A and 3B only include a portion of the componentry that would make up system 100 in accordance with the present disclosure. System 100, as shown in FIGS. 3A and 3B, includes rocker 116, mechanism plate 118, and damping component 120. FIGS. 3A and 3B further includes axes 101, in reference to which elements of FIGS. 3A and 3B are described.

As explained in reference to FIGS. 1A and 1B, linkage assembly 110 includes a plurality of moving components, such as rotary disk 112, gearing component 114, and rocker 116, that as a whole, move axially along the y-axis to open and close the circuit breaker when switch 105 is turned from the “OFF” position to the “ON” position, and from the “ON” position to the “OFF” position. In particular, rocker 116 extends a length from rotary disk 112 and gearing component 114 to rocker arm 130. To provide support for these components, and to couple these components together, linkage assembly 110 include mechanism plate 118 disposed adjacent to rocker 116 along the y-axis.

Referring first to FIG. 3A, FIG. 3A corresponds to a state of system 100 in which the circuit breaker is in the “OFF” position (see, e.g., FIG. 1A) corresponding to an “OFF” mode of the circuit breaker. When the circuit breaker is off, linkage assembly 110, and consequently switching element 145, sit in a first position corresponding to the “OFF” mode in which the stationary contacts and the moving contacts of the circuit breaker are physically separated from each other such that no current flows through the circuit breaker. In this first position, gap 122 exists within linkage assembly 120. While several gaps exist between each of the components of linkage assembly 110 allowing the components to move, shift, twist, and/or turn during a change in mode of the circuit breaker, gap 122 specifically refers to a space between a portion of rocker 116, where damper component 120 is disposed, and a distal portion of mechanism plate 118 where a bottom of mechanism plate 118 is located. Due to gap 122, the top of damping component 120 is physically separated from the bottom of mechanism plate 118.

In FIG. 3B, the circuit breaker is in the “ON” position (see, e.g., FIG. 1B) corresponding to an “ON” mode of the circuit breaker. When the circuit breaker is on, linkage assembly 110, and consequently switching element 145, has axially moved from the first position to a second position, in which the stationary contacts and the moving contacts of the circuit breaker physically touch such current flows through the circuit breaker. In this second position, gap 122 is filled as rocker 116, among other components of linkage assembly 110, shifts upward in the +y direction causing damper component 120 to collide with mechanism plate 118. While in the “ON” mode, a force produced by plunging spring 140 in the +y direction exceeds a force produced by linkage assembly 110 in the −y direction, and thus, the moving contacts stay engaged with the stationary contacts and damping component 120 remains in physical contact with mechanism plate 118.

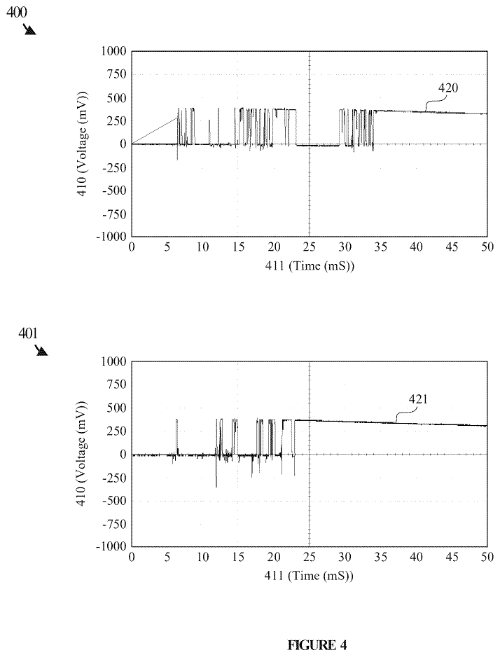

During the initial moments when the circuit breaker reaches the “ON” position after a transition from the “OFF” position, a force produced by plunging spring 140 in the +y direction is applied to stationary contacts 160 and 165 and to linkage assembly 110 via plunging mechanism 135. This force is large enough to keep moving contacts 150 and 155 engaged with stationary contacts 160 and 165, respectively, and might also cause a shock throughout linkage assembly 110. Advantageously, the inclusion of damping component 120 within gap 122 in linkage assembly 110 cushions movement of components in linkage assembly 110 produced by this force. As a result, the shock produced by the force of plunging spring 140 may be absorbed and reduced below a threshold amount such that damage to the circuit breaker and to any loads coupled to the circuit breaker is minimized or prevented. An example of the shock absorption effect of damping component 120 is shown in FIG. 4.

FIG. 4 illustrates graphical representations of signals measured at an output of system 100 in accordance with some embodiments. In particular, FIG. 4 shows graphical representation 400 that includes waveform 420 relative to voltage 410 and time 411, and graphical representation 401 that includes waveform 421 relative to voltage 410 and time 411.

In graphical representation 400, waveform 420 represents an exemplary voltage measured at an output of system 100 at a time when system 100 transitions from the “OFF” position (see, e.g., FIG. 1A) to the “ON” position (see, e.g., FIG. 1B) and moving contacts 150 and 155 engage with stationary contacts 160 and 165, respectively. In this exemplary embodiment, system 100 does not include a damper component to cushion movement of linkage assembly 110 and absorb shock produced when the sets of contacts engage with one another, such as damper component 120. Alternatively, waveform 420 may be produced by a different system, with similar or different functionality than system 100, that does not include a damper component.

At a first time (e.g., 0 milliseconds (mS) with respect to time 411), switch 105 is turned from the “OFF” position to the “ON” position. At a second time (e.g., approximately 6 mS with respect to time 411), the sets of contacts of system 100 physically touch each other, and current flows through the circuit breaker based on the sets of contacts completing a circuit that includes the circuit breaker as shown by a spike to one or more non-zero values with respect to voltage 410. In this exemplary embodiment, because the system outputting waveform 420 does not include damper component 120, voltage 410 might not settle to a near-constant value until approximately 35 mS with respect to time 411 as the sets of contacts chatter and bounce off each other repeatedly. This chatter or bouncing effect causes the moving contacts to disengage and re-engage with the stationary contacts rapidly, breaking and re-establishing the current flow, respectively, each time.

In graphical representation 401, waveform 421 also represents an exemplary voltage measured at an output of system 100 during a transition to the “ON” position. However, in this exemplary embodiment, system 100 includes damper component 120 to reduce the aforementioned bouncing effect of the sets of contacts when system 100 transitions to the “ON” position.

At a first time (e.g., 0 milliseconds (mS) with respect to time 411), switch 105 is turned from the “OFF” position to the “ON” position. At a second time (e.g., approximately 6 mS with respect to time 411), the sets of contacts of system 100 physically touch each other, and current flows through the circuit breaker based on the sets of contacts completing a circuit that includes the circuit breaker as shown by a spike to one or more non-zero values with respect to voltage 410. Eventually, at a third time (e.g., approximately 24 mS), the voltage output by system 100 settles to a near-constant value. This settling may occur at an earlier time relative to waveform 420 based on the inclusion of damper component 120 in system 100 as damper component 120 cushions movement of linkage assembly 110 when the moving contacts physically contact the stationary contacts and reduces an amount (e.g., the severity, the frequency) of the bouncing between the contacts.

More specifically, upon system 100 reaching the “ON” position, damper component 120 collides with a portion of linkage assembly 110 (e.g., mechanism plate 118, see, e.g., FIG. 3B) producing a force in the −y direction opposing the force in the +y direction by plunging spring 140, which reduces bouncing between the sets of contacts. The chatter between the sets of contacts before the settling of the output voltage may also advantageously be reduced as evidenced by waveform 421 as fewer transitions between zero (0) volts and non-zero voltages exist during the switch to the “ON” position relative to waveform 420. Thus, as shown by waveform 421, system 100 may produce a near-constant voltage sooner relative to a system that does not include damper component 120, which may improve overall circuit and circuit breaker performance.

FIG. 5 illustrates a view of system 100 in accordance with some embodiments. In FIG. 5, system 100 includes switch 105, rotary disk 112, gear interface 510, notch 515, gearing component 114, linkage assembly 110, and contact housing 520. System 100 may include fewer or additional components as compared to what is shown in the example of FIG. 5. FIG. 5 further includes axes 101, in reference to which elements of FIG. 5 are described.

In system 100 as shown in FIG. 5, switch 105 is turned to the “OFF” position and rotary disk 112 is therefore also in the “OFF” position. Gear interface 510 has rotated into the “OFF” position with rotary disk 112. As a result of gear interface 510 rotating, at least one component of gearing element 115 has rotated clockwise in response to gear interface 510 pushing gearing component 114 via notch 515. In response to such rotation of gearing component 114, linkage assembly 110 has moved out of its aligned position and into its unaligned position. In the unaligned position of linkage assembly 110, linkage assembly 110 is shifted in the −y direction compared to its aligned position in FIG. 1B, thereby causing rocker arm 130 to separate the moving contacts from the stationary contacts.

Contact housing 520 includes three sets of plunging mechanisms and associated contacts. Thus, in each of the three legs of contact housing 520, there is at least one set of moving contacts and at least one set of stationary contacts. In this way, each set of contacts may correspond to a phase of three-phase alternating current (AC) power from a power supply coupled to either the sets of moving contacts or the sets of stationary contacts.

FIG. 6A illustrates switching faceplate 605 of system 100 in accordance with some embodiments of the present technology. Switching faceplate 605 includes switch 105, “ON” position 610, “OFF” position 615, “TRIP” position 620, auxiliary port 625, auxiliary port 630, auxiliary port 635, and auxiliary port 640. System 100 may include fewer or additional components as compared to what is shown in the example of FIG. 6A. FIG. 6A further includes axes 101, in reference to which elements of FIG. 6A are described.

In the example of FIG. 6A, switch 105 is rotated to “ON” position 610. As previously described, when switch 105 is turned to “ON” position 610, rotary disk 112 is also rotated to its corresponding “ON” position. When in the “ON” position, linkage assembly 110 is in an aligned position, the moving contacts (e.g., moving contact 150 and moving contact 155) are in contact with the stationary contacts (e.g., stationary contact 160 and stationary contact 165), and current is flowing through the circuit breaker. Thus, in some embodiments, the state of switching faceplate 605 as shown in FIG. 6A corresponds to the state of system 100 in FIGS. 1B and 3B.

FIG. 6B illustrates switching faceplate 605 of system 100 in accordance with some embodiments of the present technology. Switching faceplate 605 includes switch 105, “ON” position 610, “OFF” position 615, “TRIP” position 620, auxiliary port 625, auxiliary port 630, auxiliary port 635, and auxiliary port 640. System 100 may include fewer or additional components as compared to what is shown in the example of FIG. 6B. FIG. 6B further includes axes 101, in reference to which elements of FIG. 6B are described.

In the example of FIG. 6B, switch 105 is rotated to “OFF” position 615. As previously described, when switch 105 is turned to “OFF” position 615, rotary disk 112 is also rotated to its corresponding “OFF” position. When in the “OFF” position, linkage assembly 110 is no longer in its aligned position, the moving contacts (e.g., moving contact 150 and moving contact 155) are separated from the stationary contacts (e.g., stationary contact 160 and stationary contact 165), and current is not flowing through the circuit breaker. Thus, in some embodiments, the state of switching faceplate 605 as shown in FIG. 6B corresponds to the state of system 100 in FIGS. 1A and 3A.

FIG. 6C illustrates switching faceplate 605 of system 100 in accordance with some embodiments of the present technology. Switching faceplate 605 includes switch 105, “ON” position 610, “OFF” position 615, “TRIP” position 620, auxiliary port 625, auxiliary port 630, auxiliary port 635, and auxiliary port 640. System 100 may include fewer or additional components as compared to what is shown in the example of FIG. 6C. FIG. 6C further includes axes 101, in reference to which elements of FIG. 6C are described.

In the example of FIG. 6C, switch 105 is rotated to “TRIP” position 620. As previously described, when switch 105 is turned to “TRIP” position 620, rotary disk 112 is also rotated to the “TRIP” position. Switch 105 may be turned into “TRIP” position 620 momentarily as it is being rotated between “ON” position 610 and “OFF” position 615. However, in some scenarios, switch 105 cannot be turned past “TRIP” position 620 when it is turned toward “OFF” position 615 from “ON” position 610.

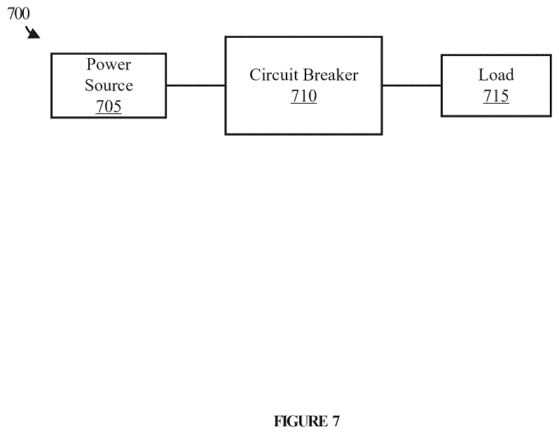

FIG. 7 illustrates circuit 700 in which a circuit breaker in accordance with the present disclosure may be implemented. Circuit 700 includes power source 705, circuit breaker 710, and load 715. Circuit 700 may include fewer or additional components as compared to what is shown in the example of FIG. 7.

Power source 705 is representative of any device or electrical component delivering power into circuit 700. Power source 705 may be an independent voltage source, a dependent voltage source, or other type of voltage source. Examples of such power sources include generators, photovoltaic cells, thermopiles, primary-cell batteries, a power grid, and the like. Power source 705 creates electrical voltage that causes current to flow through circuit 700 via one or more connecting wires or other connection components. Load 715 is representative of any device or electrical component that consumes electrical energy. Load 715 may represent a resistive load, inductive load, capacitive load, or combined load. Examples of loads include electric lamps, air conditioners, motors, resistors, heaters, processors, precision manufacturing equipment, data servers, pumps, fans, generators, robotic machinery, industrial automation controllers, and the like. Circuit breaker 710 is representative of any circuit breaker in accordance with the technology disclosed herein. For example, circuit breaker 710 may be representative of system 100 from the preceding figures. Circuit breaker 710 may alternatively be representative of a circuit breaker system that differs from system 100 but nonetheless includes damper component 120 or a similar component with similar properties and that operates consistently relative to damper component 120.

In accordance with the example of FIG. 7, current flows from power source 705 to load 715. Circuit breaker 710 protects circuit 700, including power source 705 and load 715, by stopping the flow of current in cases of short circuit or overload. Thus, in accordance with the present disclosure, circuit breaker 710 is a circuit breaker that may include, for example, thermal tripping elements, magnetic tripping elements, microprocessor tripping elements, electronic tripping elements, or a combination thereof. In normal operation, circuit breaker 710 may open circuit 700 to stop current flow when an overcurrent condition or short circuit condition occurs.

The above description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Unless the context clearly requires otherwise, throughout the description and the claims, the words “include,” “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description is not intended to be exhaustive or to limit the technology to the precise form disclosed above. While specific examples of the technology are described for illustrative purposes, various equivalent modifications are possible within the scope of the technology, as those skilled in the relevant art will recognize. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in several ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A circuit breaker comprising:
a switch rotatable about a first axis, wherein the switch includes:
an on position corresponding to an on mode of the circuit breaker,
an off position corresponding to an off mode of the circuit breaker, and
a trip position corresponding to a trip mode of the circuit breaker;
a linkage assembly coupled to the switch and movable axially along the first axis based on a rotation of the switch;
a set of stationary contacts;
a set of moving contacts, wherein:
the set of moving contacts change position between a first position corresponding to the off position of the switch and a second position corresponding to the on position of the switch in response to movement of the linkage assembly caused by rotation of the switch between the off position and the on position,
the set of moving contacts do not physically touch the set of stationary contacts in the first position corresponding to the off position of the switch stopping current flow through the circuit breaker in the off mode, and
the set of moving contacts physically touch the set of stationary contacts in the second position corresponding to the on position of the switch allowing current flow through the circuit breaker in the on mode;
a spring coupled to the set of moving contacts and configured to provide a first force opposing a second force produced by the movement of the linkage assembly; and
a damper component comprising a cushioning material, coupled to the linkage assembly, and disposed to absorb a shock created by the first force when the set of moving contacts changes position between the first position and the second position by cushioning the movement of the linkage assembly.

2. The circuit breaker of claim 1, further comprising a mechanism plate disposed adjacent to the linkage assembly and extending along the first axis, wherein a first end of the mechanism plate is adjacent to a proximal end of the linkage assembly, and a second end of the mechanism plate is adjacent to a medial portion of the linkage assembly such that a gap exists between a distal end of the linkage assembly and the second end of the mechanism plate.

3. The circuit breaker of claim 2, wherein the damper component is coupled to the linkage assembly within the gap.

4. The circuit breaker of claim 3, wherein:
the gap shrinks in response to movement of the linkage assembly caused by rotation of the switch between the off position and the on position;
in the off position, the damper component does not physically touch the portion of the mechanism plate at the distal end of the mechanism plate; and
in the on position, the damper component physically touches the portion of the mechanism plate at the distal end of the mechanism plate such that the gap is filled by the damper component.

5. The circuit breaker of claim 1, wherein the damper component is coupled to the linkage assembly at an optimal position of the linkage assembly to absorb the shock.

6. The circuit breaker of claim 1, wherein the cushioning material comprises rubber.

7. The circuit breaker of claim 1, wherein dimensions of the damper component are selected based on a desired force reduction percentage.

8. The circuit breaker of claim 1, wherein the linkage assembly comprises:
a rocker arm coupled to the set of moving contacts, wherein the movement of the linkage assembly moves the rocker arm and, in response, the set of moving contacts change position between the first position and the second position.

9. The circuit breaker of claim 8, wherein the damper component is coupled to the rocker arm of the linkage assembly.

10. The circuit breaker of claim 1, wherein:
the switch comprises a rotating knob;
the rotating knob rotates ninety degrees between the on position and the off position; and
the trip position is within the ninety degrees between the on position and the off position.

11. A circuit breaker, comprising:
a switch;
a linkage assembly coupled to the switch;
a set of stationary contacts;
a set of moving contacts coupled to the linkage assembly;
a spring coupled to the set of moving contacts; and
a damper component comprising a shock absorbing material and coupled to the linkage assembly;
wherein:
the switch rotates from an off position corresponding to an off mode of the circuit breaker to an on position corresponding to an on mode of the circuit breaker,
in response to the rotation of the switch, the linkage assembly moves from a first position corresponding to the off mode of the circuit breaker to a second position corresponding to the on mode of the circuit breaker,
the movement of the linkage assembly from the first position to the second position reduces a force applied by the linkage assembly on the spring causing the set of moving contacts to engage with the set of stationary contacts,
the engagement of the set of moving contacts with the set of stationary contacts produces a shock, and
the damper component collides with an element of the linkage assembly to absorb at least a portion of the shock thereby reducing a bouncing effect between the set of moving contacts and the set of stationary contacts.

12. The circuit breaker of claim 11, wherein the element of the linkage assembly comprises a mechanism plate disposed adjacent to the linkage assembly and extending along the first axis, wherein a first end of the mechanism plate is adjacent to a proximal end of the linkage assembly, and a second end of the mechanism plate is adjacent to a medial portion of the linkage assembly such that a gap exists between a distal end of the linkage assembly and the second end of the mechanism plate.

13. The circuit breaker of claim 12, wherein the damper component is coupled to the linkage assembly within the gap.

14. The circuit breaker of claim 13, wherein:
the gap shrinks in response to the movement of the linkage assembly;
in the off position, the damper component does not physically touch the portion of the mechanism plate at the distal end of the mechanism plate; and
in the on position, the damper component physically touches the portion of the mechanism plate at the distal end of the mechanism plate such that the gap is filled by the damper component.

15. The circuit breaker of claim 11, wherein the damper component is coupled to the linkage assembly at an optimal position of the linkage assembly to absorb the shock.

16. The circuit breaker of claim 11, wherein the cushioning material comprises rubber.

17. The circuit breaker of claim 11, wherein dimensions of the damper component are selected based on a desired force reduction percentage.

18. The circuit breaker of claim 11, wherein the linkage assembly comprises:
a rocker arm coupled to the set of moving contacts, wherein the movement of the linkage assembly moves the rocker arm and, in response, causes the engagement or disengagement of the set of moving contacts and the set of stationary contacts.

19. The circuit breaker of claim 8, wherein the damper component is coupled to the rocker arm of the linkage assembly.

20. A method of manufacturing a circuit breaker that reduces a bouncing effect between a set of moving contacts and a set of stationary contacts of the circuit breaker, the method comprising:
positioning a switch configured to rotate from an off position corresponding to an off mode of the circuit breaker to an on position corresponding to an on mode of the circuit breaker;
coupling a linkage assembly to the switch, the linkage assembly configured to, in response to a rotation of the switch, move from a first position corresponding to the off mode of the circuit breaker to a second position corresponding to the on mode of the circuit breaker;
coupling the set of moving contacts to the linkage assembly;
coupling a spring to the set of moving contacts; and
coupling a damper component comprising a shock absorbing material to the linkage assembly;
wherein:
the movement of the linkage assembly from the first position to the second position reduces a force applied by the linkage assembly on the spring causing the set of moving contacts to engage with the set of stationary contacts,
the engagement of the set of moving contacts with the set of stationary contacts produces a shock, and
the damper component collides with an element of the linkage assembly to absorb at least a portion of the shock thereby reducing the bouncing effect between the set of moving contacts and the set of stationary contacts.
